(19) United States
(12) Patent Application Publication
(10) Pub. No.: US 2012/0210260 A1
(43) Pub. Date: Aug. 16, 2012

(54) Techniques Providing Spatial Consistency of Graphical Elements

(75) Inventors: Benjamin B. Bederson, Chevy Chase, MD (US); John SanGiovanni, Seattle, WA (US)

(73) Assignee: Zumobi, Inc., Seattle, WA (US)

(21) Appl. No.: 12/836,427

(22) Filed: Jul. 14, 2010

(51) Int. Cl. G06F 3/048

(52) U.S. Cl. 715/765

(57) ABSTRACT

A computer-implemented method is described. The method is performed upon a multi-orientation display device and includes displaying a plurality of graphical elements within a User Interface (UI) upon the display device, where the plurality of graphical elements have a respective first aspect ratio, reorienting the UI with respect to the display device, and adjusting the plurality of graphical elements to have a respective second aspect ratio in response to the reorienting.

### TECHNICAL FIELD

The present disclosure relates, in general, to user interfaces and, more specifically, to user interfaces that adapt to reorientation of a display device.

### BACKGROUND

In the last decade people have changed the way they consume content. One big shift is the ubiquity of smart phones and other handheld devices that offer access to web-based content and media applications (“apps”). However, handheld devices tend to have limitations. In particular, people tend to use phones for short bursts of time. In one example, a user is waiting in a line and pulls out his or her phone to use for ninety seconds or so. The user may read an article or search for a particular small piece of information. In general, handheld content consumption tends to be quite targeted. It is generally assumed that, because the screen is kept small, handheld devices are annoying to use. Users typically do not want to use handheld devices for significant content consumption. Of course, the above-described phenomenon is a generality, and some users employ handheld devices for more than that, but the above-described use is the preferred use modality.

Recently, tablet or slate computers have become increasingly popular. Tablet computers usually have a touchscreen about the size of a typical laptop computer's screen or larger while omitting an integrated, physical keyboard. The tablet computer provides a virtual keyboard upon the touchscreen when needed. In general, tablet computers have a slightly different use modality than do handheld devices or laptops because of their larger screens. For instance, people tend to use tablet computers for longer stretches of time than they do with handheld devices.

Touchscreen handheld devices and tablet computers sometimes employ multi-orientation display screens. For instance, both the iPhone™ and the iPad™ (available from Apple, Inc.) allow a user to turn the screen from landscape to portrait and back again, with the user interface adapting to the reorientation, rotating the content upon the screen to suit the given orientation. In one particular example, the iPad™ tablet computer has icons upon its home screen arranged in regular rows and columns (e.g., five rows by four columns in portrait mode). As the tablet computer is reoriented to landscape mode, the icons are rearranged in four rows by five columns with the same aspect ratio and size as the portrait orientation. However, in rearranging the icons, the spatial placement of the icons are changed. For example, the top rightmost icon in portrait mode is not the top rightmost icon in landscape mode, and a user focused on the top rightmost icon may find the rearrangement disorienting. It is more desirable to have techniques that provide spatial consistency.

### BRIEF SUMMARY

Various embodiments of the present invention include systems, methods, and computer program products to provide a Graphical User Interface (GUI) upon a multi-orientation screen, where the GUI adapts to reorientation of the screen by changing a size and/or shape of the graphical elements to preserve spatial consistency. The graphical elements can include icons, interactive “widgets,” and/or the like.

In one example, the GUI has a matrix of widgets (e.g., a five-by-four matrix), and the GUI provides for reorientation. As an orientation of the GUI is changed, the GUI adapts to maintain spatial consistency within the matrix of widgets by changing an aspect ratio of the widgets themselves. The changing aspect ratio allows the widgets to be shown in the five-by-four matrix even though the aspect ratio of the GUI may have changed during reorientation.

In some embodiments, the graphical elements have the same aspect ratio as the GUI and change in aspect ratio as the GUI changes its aspect ratio. In other embodiments, one or more of the graphical elements may have a differing aspect ratio than the GUI and/or than other graphical elements, yet such graphical elements change aspect ratio as the GUI is reoriented. Various embodiments provide an elegant technique to maintain spatial consistency of graphical elements within a GUI.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 is an illustration of exemplary Graphical User Interface (GUI) adapted according to one embodiment of the invention;

FIG. 2 is an illustration of the exemplary GUI of FIG. 1 reoriented;

FIG. 3 is an illustration of exemplary Graphical User Interface (GUI) adapted according to one embodiment of the invention;

FIG. 4 shows the widget arrangement of FIG. 3 preserved through a change from landscape to portrait orientation;

FIG. 5 is an illustration of an exemplary GUI adapted according to one embodiment of the invention, where a user may pin and move graphical elements;

FIG. 6 is an illustration of an exemplary GUI adapted according to one embodiment of the invention, where a user may select and move two or more graphical elements at the same time;

FIG. 7 is an illustration of an exemplary method adapted according to one embodiment of the invention;

FIG. 8 is an illustration of an exemplary system adapted according to one embodiment of the invention; and

FIG. 9 illustrates an example computer system adapted according to one embodiment of the present invention.

### DETAILED DESCRIPTION OF THE INVENTION

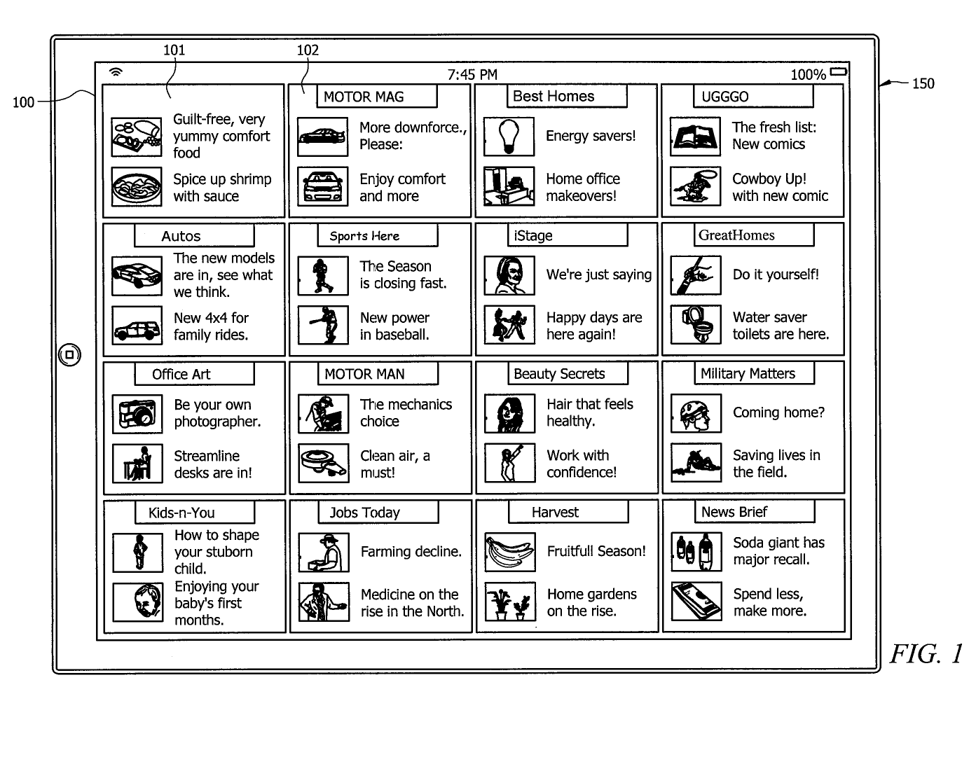

FIG. 1 is an illustration of exemplary Graphical User Interface (GUI) 100 adapted according to one embodiment of the invention. In one example, GUI 100 is presented upon a display screen of processor-based device 150. Appropriate processor-based devices include but are not limited to laptop computers, desktop computers, tablet computers (e.g., the iPad™, available from Apple, Inc.), and portable devices that have multi-orientation display screens. Some embodiments are especially adapted for use with touchscreen devices, though the scope of embodiments is not so limited, as devices that use computer pointing devices (e.g., a mouse or touchpad) may be adapted for use in some designs as well. In some embodiments, GUI 100 is part of app that is downloaded and run on a processor-based device, while other embodiments may implement GUI 100 as a plug-in for a browser, an interface for a website, and/or the like.

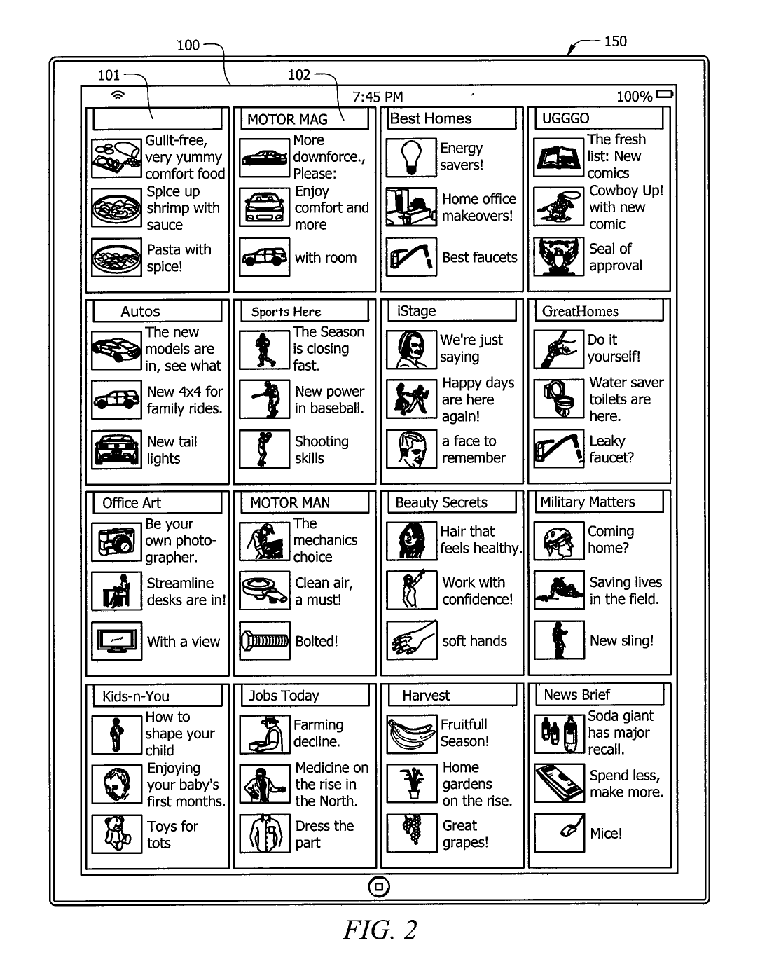

GUI 100 includes sixteen widgets, such as widgets 101 and 102, arranged in a matrix of four rows by four columns. Each of the widgets has the same aspect ratio, where the widgets are wider than they are tall. In FIG. 1, GUI 100 is shown in landscape orientation. As the device 150 is rotated, GUI 100 adapts by changing to portrait orientation, as shown in FIG. 2.

Of note in FIG. 2 is that the widgets in GUI 100 have retained their relative positions so that the four-by-four matrix is preserved. For instance, in FIG. 1, widget 102 is in the first row, second column, and such relative placement is preserved in FIG. 2. GUI 100 changes the aspect ratio of the widgets so that the widgets in FIG. 2 are taller than they are wide. Further, in both FIGS. 1 and 2, the aspect ratio of the individual widgets matches that of GUI 100.

In addition to changing the aspect ratios of the widgets, GUI 100 also changes the content of the widgets. For instance, in FIG. 1, widget 101 shows previews of two articles. By contrast, in FIG. 2, widget 101 shows previews for three articles, thereby taking advantage of the taller characteristic of the widgets in FIG. 2.

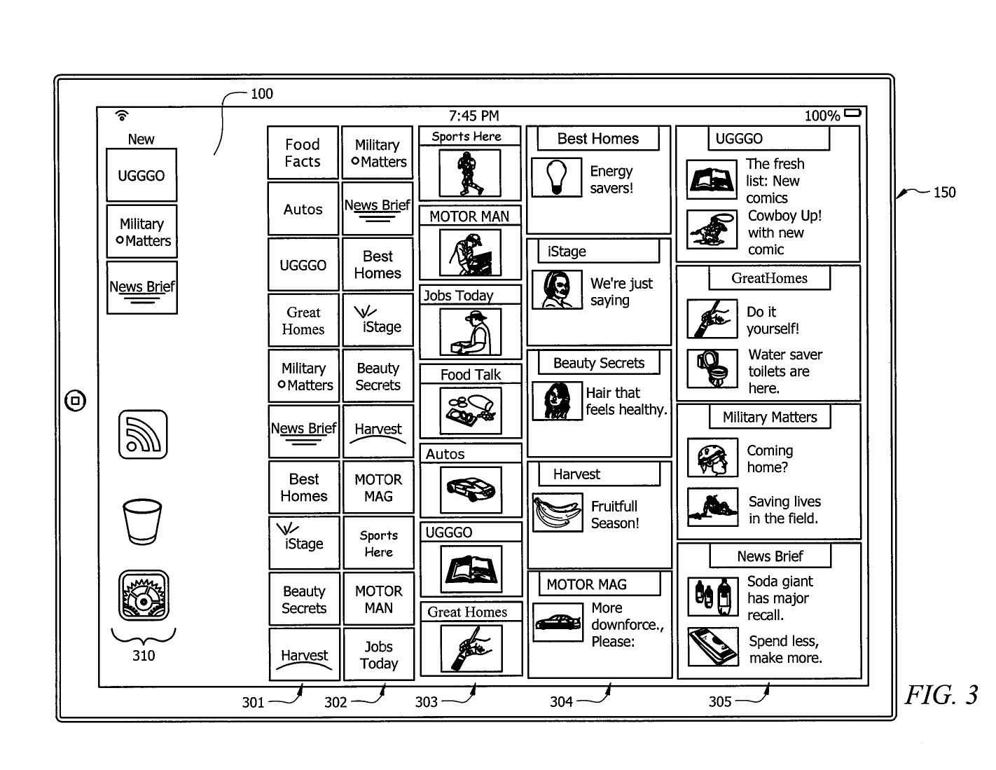

FIG. 3 is an illustration of exemplary Graphical User Interface (GUI) 100 adapted according to one embodiment of the invention. FIG. 3 shows GUI 100 on device 150 with a different set of graphical elements. Specifically, GUI 100 includes two columns that have icons 301, 302. There are also three columns that have widgets 303-305. Generally, icons show simple fixed content (such as a logo of a content provider) that does not change. Widgets, by contrast, usually show richer content that changes over time. In one example, a widget provides a preview of the underlying material that is accessible by tapping on the widget.

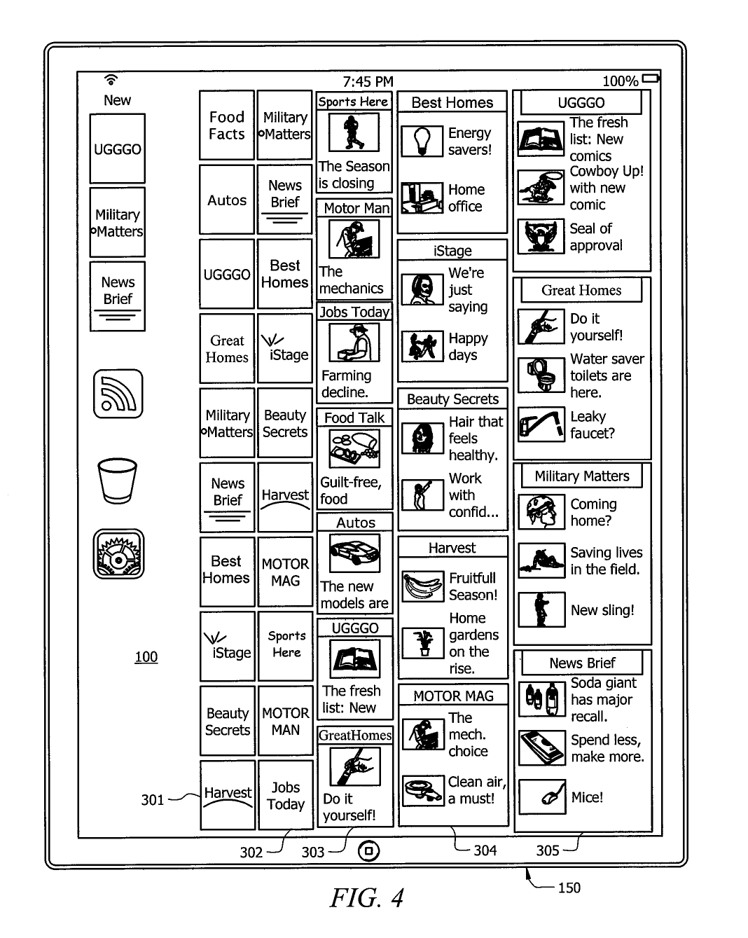

FIG. 3 illustrates that some embodiments may be adapted for use with graphical elements that have different shapes and/or sizes, even within the same GUI. For instance, graphical elements 301-305 all have different sizes. FIG. 4 shows the widget arrangement of FIG. 3 preserved through a change from landscape to portrait orientation, and the aspect ratio of the graphical elements is changed. In other words, even though there are four different sizes of graphical elements, they are all either portrait or landscape aspect ratio in each respective mode.

Also of note in FIGS. 3 and 4 is that column 310 has control icons. Such control features can be modified as the other graphical elements are modified (e.g., by changing aspect ratio with orientation). In other embodiments, such control features may be exempted from the size/shape modifications. In fact, one or more portions of the space in GUI 100 may be used for control features or other kinds of features and may be exempted from some modifications.

In FIGS. 1-4, the aspect ratios of the graphical elements match that of GUI 100. Such feature provides at least one advantage in some embodiments. Specifically, in scenarios wherein the aspect ratio of a graphical element does not match the aspect ratio of the screen, then it can be difficult to make a zoom-in transition look pleasing to a user. Users sometimes find a zoom that also includes a modification of the aspect ratio to be unpleasing, and when an aspect ratio of a graphical element does not match the aspect ratio of the screen, the aspect ratio sometimes must be changed between the zoomed-in and zoomed-out views. By contrast, in the embodiments of FIGS. 1-4, the aspect ratio of the graphical elements matches the aspect ratio of the screen. Therefore, a zooming transition during reorientation may be more pleasing because the user zooms right into a selected graphical element, and it will exactly fill the screen when it zooms all the way in.

While FIGS. 1-4 show an embodiment wherein an aspect ratio and content of widgets are changed, the scope of embodiments is not so limited. For instance, in some embodiments, another display form, such as a basic shape of graphical elements may be changed. Also, some embodiments may or may not change content in individual graphical elements taking into account, e.g., resulting size/shape, ease of reading, etc.

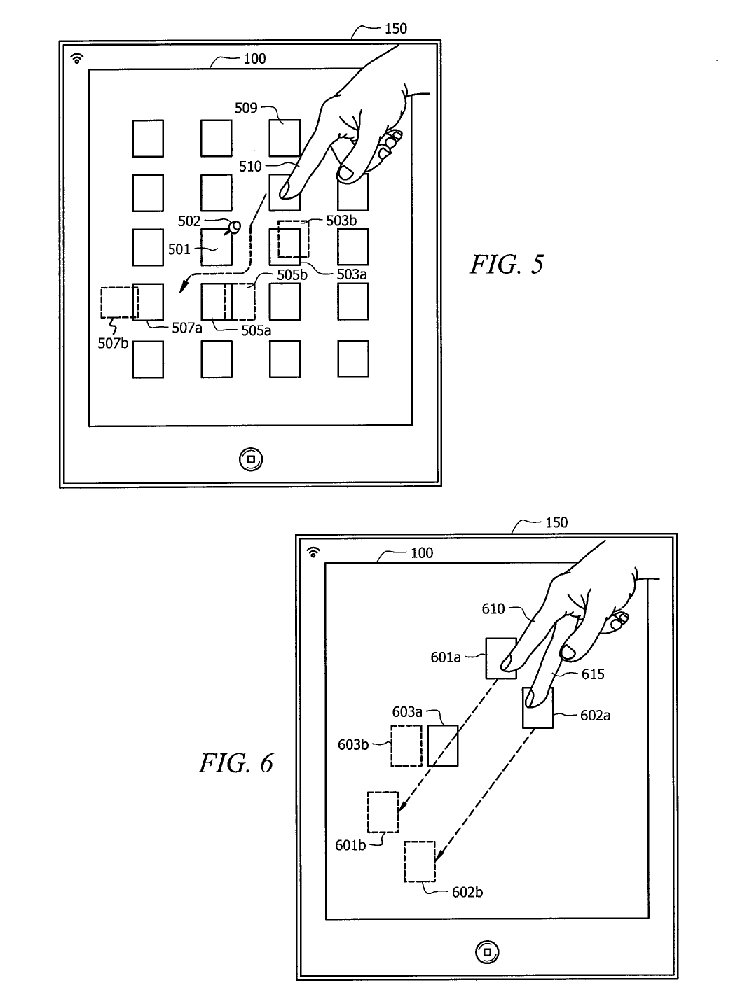

FIG. 5 is an illustration of exemplary GUI 100 adapted according to one embodiment of the invention, where a user may pin and move graphical elements. Within GUI 100 is a matrix of graphical elements, including graphical elements 501, 503, 505, 507, and 509. User finger 510 is shown touching the display screen of device 150 to manipulate the placement of the various graphical elements.

Specifically, user finger 501 selects an item (in this case, graphical element 509) and moves it around the display screen as shown by the dashed line path. As graphical element 509 moves, the other graphical elements 503, 505, and 507 move to make space for graphical element 509, as shown by the original and moved positions of graphical elements 503, 505, 507 in solid and dashed lines, respectively. Graphical elements 503, 505, and 507 may or may not return to their original positions after graphical element 509 is moved, depending on the final placement of graphical element 509.

Of note in FIG. 5 is thumbtack 502 placed in graphical element 501, which, as described below, constrains the movement of graphical element 501 somewhat. The concept of pinning has been used in the past (e.g., in Windows™ 7) with a linear list of dynamically changeable items, such as a list of recently used files. If, e.g., the list is ten items long, and an eleventh item is added, the first item may get popped off of the top. However, a pin can be used to keep the place of the first item so that the first item is not moved.

FIG. 5 shows a pinning concept added to the spatially manipulable environment of GUI 100. In the example of FIG. 5, if the user selects thumbtack 502, then item 501 moves to the top of its respective column. In some embodiments, thumbtacked items may be automatically moved to the tops of respective columns so that they are snapped into place at the top of the display screen.

Also, as other items are selected and moved around the display screen, such action does not change the position of the thumbtacked items. Rather, a moving item (e.g., graphical element 509) moves around the thumbtacked item (e.g., graphical element 501) as it traverses its path. Thumbtacks may help to alleviate the entropy seen by a user as items are moved around the display screen. For instance, a few of the user's most frequently used or important graphical elements can be thumbtacked so that they keep their places even as surrounding items may be displaced.

FIG. 6 is an illustration of exemplary GUI 100 adapted according to one embodiment of the invention, where a user may select and move two or more graphical elements at the same time. In FIG. 6, GUI 100 includes graphical elements 601, 602, 603. A human user employs fingers 610, 615 to manipulate the graphical elements on the display screen.

In one example, a human user presses down on the display screen with two fingers 610, 615 at the same time to select graphical elements 601, 602. The user then moves the two graphical elements 601, 602 simultaneously as shown by their first positions at 601a, 602a and their subsequent positions 601b, 602b. As graphical elements 601, 602 traverse the display screen, graphical element 603 temporarily moves out of the way and then returns to its position as shown by its original position at 603a and its temporary position 603b.

Such feature can be quite appealing to a user of a touchscreen device because such feature is elegant and intuitive. For instance, a user can use his or her entire hand to grab, e.g., five items, and move them over by one or more rows or columns. In fact, such feature may be used to move an entire row or column of items, rather than moving a group of items item-by-item.

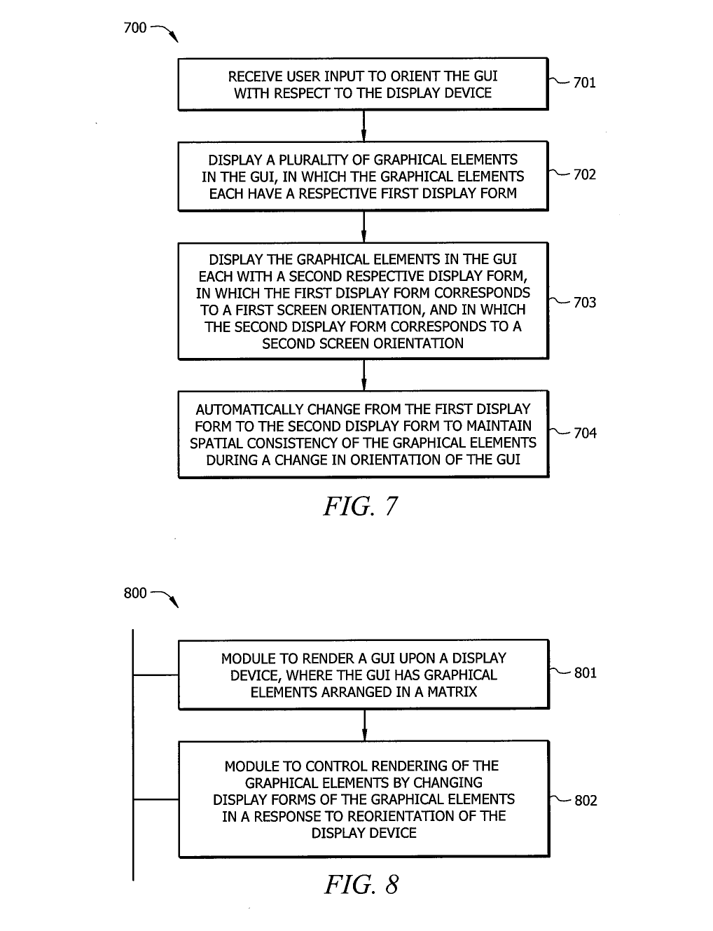

Various embodiments of the present invention include methods to perform the various functions described above. FIG. 7 is an illustration of exemplary method 700 adapted according to one embodiment of the invention. Method 700 may be performed, for example, by a processor-based device executing a program that instantiates the functional modules shown in FIG. 8. Examples of processor-based devices that may perform method 700 include any device that can accommodate a multi-orientation display screen.

In block 701, user input is received to orient the GUI with respect to the display device. In block 702, a plurality of graphical elements are displayed in the GUI. The graphical elements each have a respective first display form. The graphical elements can all be the same size and shape or be of different sizes and shapes.

In block 703, the graphical elements in the GUI are displayed each with a second respective display form. In this example, the first display forms of the graphical elements correspond to a first screen orientation, and the second display forms correspond to a second screen orientation. After the reorientation of the screen, the graphical elements can, once again, be all of the same size/shape or be of different sizes/shapes.

In method 700, the GUI changes from the first display forms to the second display forms to maintain spatial consistency of the graphical elements during a change in orientation of the display screen. For instance, in one example, the graphical elements may change a shape (e.g., rectangle to square or equilateral triangle to right triangle). In another example, the graphical elements change aspect ratio so that at least two dimensions of the graphical elements are changed, though the basic shapes remain the same. In one specific example, the graphical elements have the same aspect ratio as the GUI, and as the display screen is reoriented, the aspect ratios of the graphical elements and the GUI change correspondingly.

Various embodiments are not limited to the exact method shown in FIG. 7. Various embodiments may add, omit, rearrange, or modify actions. For instance, some embodiments include a feature wherein graphical elements can be moved across the display screen while other graphical elements move out of the way. Various embodiments may also provide for thumbtacking, where some graphical elements can be pinned to positions in the GUI. Also, various embodiments may provide for moving multiple graphical elements at the same time. Furthermore, the method 700 may be performed by a default GUI provided by an operating system, a GUI provided by an application or program running on the operating system, a plug-in for a web browser or other application, and/or the like.

FIG. 8 is an illustration of an exemplary system 800 adapted according to one embodiment of the invention. System 800 includes functional modules 801 and 802. The divisions of the functional modules is conceptual and exemplary, as the functions may be performed by a single functional unit or divided between two or more functional units different than those shown in FIG. 8.

Some embodiments include one or more advantages over other techniques. For instance, various embodiments provide a GUI that is more intuitive than previous attempts at adjusting to screen reorientation. Whereas previous techniques may cause rows and/or columns of graphical elements to be rearranged, various embodiments of the present invention provide a technique that preserves spatial relationships and relative placements of graphical elements even after reorientation.

When implemented via computer-executable instructions, various elements of embodiments of the present invention are in essence the software code defining the operations of such various elements. The executable instructions or software code may be obtained from a tangible readable medium (e.g., a hard drive media, optical media, RAM, EPROM, EEPROM, tape media, cartridge media, flash memory, ROM, memory stick, and/or the like). In fact, readable media can include any medium that can store information.

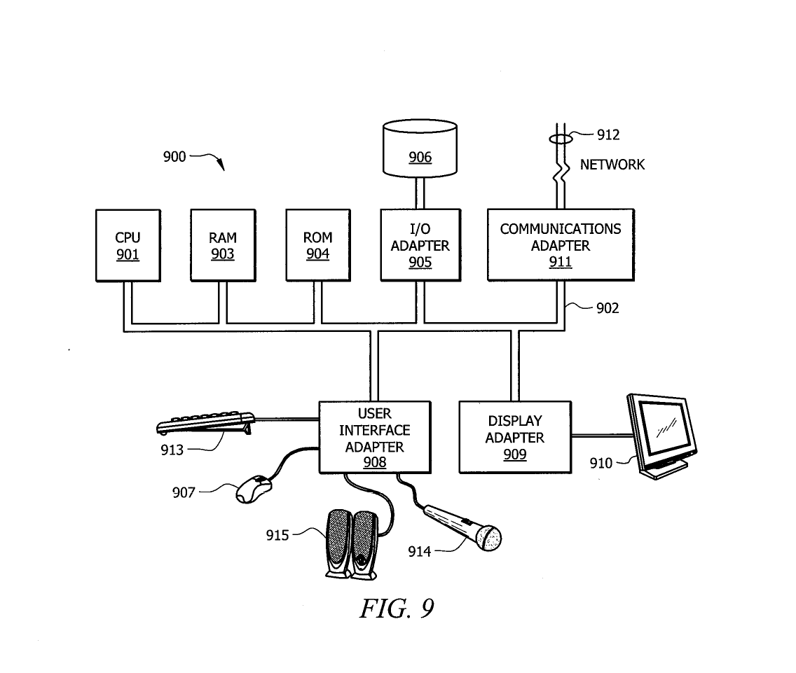

FIG. 9 illustrates an example computer system 900 adapted according to one embodiment of the present invention. That is, computer system 900 comprises an example system on which embodiments of the present invention may be implemented (such as processor-based device 150 of FIG. 1). Central processing unit (CPU) 901 is coupled to system bus 902. CPU 901 may be any general purpose or specialized purpose CPU. However, the present invention is not restricted by the architecture of CPU 901 as long as CPU 901 supports the inventive operations as described herein. CPU 901 may execute the various logical instructions according to embodiments of the present invention. For example, one or more CPUs, such as CPU 901, may execute machine-level instructions according to the exemplary operational flows described above in conjunction with FIG. 7.

Computer system 900 also preferably includes random access memory (RAM) 903, which may be SRAM, DRAM, SDRAM, or the like. In this example, computer system 900 uses RAM 903 to instructions, media content, and the like. Computer system 900 preferably includes read-only memory (ROM) 904 which may be PROM, EPROM, EEPROM, or the like. RAM 903 and ROM 904 hold user and system data and programs, as is well known in the art.

Computer system 900 also preferably includes input/output (I/O) adapter 905, communications adapter 911, user interface adapter 908, and display adapter 909. I/O adapter 905, user interface adapter 908, and/or communications adapter 911 may, in certain embodiments, enable a user to interact with computer system 900 in order to input information, such as hand gestures (via a touchscreen or a pointing device) that indicate that one or more graphical elements should be selected and/or moved. Additionally, I/O adapter 905, user interface adapter 908, and/or communications adapter 911 may allow for other information to be input, such as information indicating that a GUI should be reoriented (by, e.g., detecting that a display screen has been physically reoriented).

I/O adapter 905 preferably connects to storage device(s) 906, such as one or more of hard drive, compact disc (CD) drive, floppy disk drive, tape drive, etc. to computer system 900. The storage devices may be utilized when RAM 903 is insufficient for the memory requirements associated with storing data. Communications adapter 911 is preferably adapted to couple computer system 900 to network 912 (e.g., the Internet, a LAN, a cellular network, etc.). User interface adapter 908 couples user input devices, such as keyboard 913, pointing device 907, and microphone 914 and/or output devices, such as speaker(s) 915 to computer system 900. Display adapter 909 is driven by CPU 901 to control the display on display device 910 to, for example, display the GUI.

While the above examples are provided in the context of tablet computers with touchscreens, the scope of embodiment is not so limited. For instance, some embodiments may be adapted for use with handheld devices, laptop computers, desktop computers, workstations, and/or other processor-based devices with a multi-orientation display screen. Additionally, some embodiments can be used with devices that do not have a touchscreen but, instead, rely on another manner of screen navigation, such as pointing, hotkeys, and the like. Moreover, embodiments of the present invention are not limited to general purpose computers and may be implemented on other types of processors, such as application specific integrated circuits (ASICs) or very large scale integrated (VLSI) circuits. In fact, persons of ordinary skill in the art may utilize any number of suitable structures capable of executing logical operations according to the embodiments of the present invention.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A computer program product having a computer readable medium tangibly recording computer program logic for displaying a User Interface (UI) upon a multi-orientation display device, the computer program product comprising:
code to receive user input to orient the UI with respect to the display device;
code to display a plurality of graphical elements in the UI, in which the graphical elements have respective first display forms;
code to display the graphical elements in the UI with second respective display forms, in which the first display forms correspond to a first display device orientation, and in which the second display forms correspond to a second display device orientation; and
code to automatically change from the first display forms to the second display forms to maintain spatial consistency of the graphical elements during a change in orientation of the UI.

2. The computer program product of claim 1 in which the graphical elements include at least one of icons and elements with content that changes.

3. The computer program product of claim 1 in which the code to automatically change from the first display forms to the second display forms comprises:
code to change respective aspect ratios of the graphical elements.

4. The computer program product of claim 1 in which the plurality of graphical elements have the same aspect ratio as the UI.

5. The computer program product of claim 1 further comprising code to provide for pinning ones of the graphical elements to respective placements on the UI, the pinning constraining movement of the ones of the graphical elements.

6. The computer program product of claim 1 further comprising:
code to allow two or more of the graphical elements to be selected and moved at the same time.

7. The computer program product of claim 1 in which ones of the graphical elements have sizes different from sizes of others of the graphical elements.

8. The computer program product of claim 1 in which the UI comprises a portion for control elements with display forms that are not modified with reorientation of the display device.

9. The computer program product of claim 1 in which the plurality of graphical elements are arranged in a matrix of rows and columns.

10. A computer program product having a computer readable medium tangibly recording computer program logic for displaying a User Interface (UI) upon a multi-orientation display device, the computer program product comprising:
code to display a group of graphical elements in the UI, in which the graphical elements each have a respective first aspect ratio; and
code to display the group of graphical elements in the UI each having a respective second aspect ratio;
in which the respective first aspect ratio corresponds to a first screen orientation, and in which the respective second aspect ratio corresponds to a second screen orientation.

11. The computer program product of claim 10 further comprising:
code to reorient the UI with respect to the display device in response to user input; and
code to change from the respective first aspect ratio to the respective second aspect ratio in response to reorienting the UI.

12. The computer program product of claim 10 in which the graphical elements are arranged in a matrix of rows and columns in the UI.

13. The computer program product of claim 12 in which ones of the graphical elements have sizes different than other ones of the graphical elements.

14. The computer program product of claim 10 in which the first respective aspect ratios of the graphical elements match a first aspect ratio of the UI in a first orientation, and in which the second respective aspect ratios of the graphical elements match a second aspect ratio of the UI in a second orientation.

15. A system comprising:
a first module to render a User Interface (UI) upon a display device, the UI having graphical elements therein in a matrix; and
a second module to control rendering of the graphical elements, the second module changing respective aspect ratios of the graphical elements in response to reorientation of the display device to maintain an arrangement of the graphical elements within the matrix.

16. The system of claim 15 implemented in at least one of:
a tablet computer; and
a handheld device.

17. The system of claim 1 in which the respective aspect ratios of the graphical elements match a first aspect ratio of the UI in a first orientation and match a second aspect ratio of the UI in a second orientation.

18. The system of claim 1 in which the graphical elements include at least one of icons and elements with content that changes.

19. The system of claim 1 in which the display device comprises a touchscreen.

20. A computer-implemented method, the method performed upon a multi-orientation display device, the method comprising:
displaying a plurality of graphical elements within a User Interface (UI) upon the display device, where the plurality of graphical elements have a respective first aspect ratio;
reorienting the UI with respect to the display device; and
adjusting the plurality of graphical elements to have a respective second aspect ratio in response to the reorienting.

21. The method of claim 20 in which the graphical elements include at least one of icons, widgets, and elements with content that changes.

22. The method of claim 20 performed by at least one of:
a tablet computer; and
a handheld device.

23. The method of claim 20 in which the first respective aspect ratio matches a first aspect ratio of the UI in a first orientation, and in which the second respective aspect ratio matches a second aspect ratio of the UI in a second orientation.
